(19) United States
(12) Patent Application Publication
(10) Pub. No.: US 2013/0204737 A1
(43) Pub. Date: Aug. 8, 2013

(54) LEVERAGING STORE ACTIVITY FOR RECOMMENDATIONS

(71) Applicants: Shubham Agarwal, Arlington Heights, IL (US); Mark Seth Bonchek, Weston, MA (US); Eui Chung, Huntley, IL (US)

(72) Inventors: Shubham Agarwal, Arlington Heights, IL (US); Mark Seth Bonchek, Weston, MA (US); Eui Chung, Huntley, IL (US)

(21) Appl. No.: 13/749,355

(22) Filed: Jan. 24, 2013

Related U.S. Application Data
(60) Provisional application No. 61/594,792, filed on Feb. 3, 2012.

(51) Int. Cl. G06Q 30/02

(52) U.S. Cl. CPC G06Q 30/0282
USPC 705/26.7

(57) ABSTRACT

Systems and methods for providing product recommendations to a customer are described. One embodiment includes receiving a request for a product recommendation for a customer, and generating the product recommendation based on a purchase history for the customer. In some embodiments, the purchase history includes data associated with in-store purchases from one or more brick and mortar stores and data associated with online purchases from one or more online stores.

### CROSS-REFERENCE TO RELATED APPLICATIONS/INCORPORATION BY REFERENCE

This application claims the benefit of U.S Provisional Application No. 61/594,792, entitled “SYSTEMS AND METHODS FOR LEVERAGING STORE ACTIVITY FOR ONLINE RECOMMENDATIONS” which was filed Feb. 3, 2012, the disclosure of which is expressly hereby incorporated by reference herein in its entirety.

### FIELD OF THE DISCLOSURE

The present disclosure relates generally to recommending products and/or services to customers and to enhancing social experiences for such customers.

### BACKGROUND OF THE INVENTION

Historically, when a customer desired to purchase a product, the customer traveled to a retail establishment to purchase the product. If the customer frequently purchased from the same retail establishment, the customer over time may develop a relationship with a salesperson. The salesperson, based on such frequent contact with the customer, may develop a sense of which products that the customer may like or have an interest in purchasing. The salesperson may then provide tailored recommendations for other products that the customer may like to purchase. The above conventional process may result in a very personal shopping experience for the customer. However, such process is also very dependent upon the salesperson and their knowledge gathered over long periods of time. If the salesperson leaves the retail establishment or is not on duty when the customer is on the premises, such knowledge base is lost and the retail establishment is unable to provide the customer with the same level of personalized recommendations.

Over the last decade or so, customers are making more and more purchases via the Internet from various online vendors. Such online vendors commonly track prior purchases of a customer. The online vendors may present customers with recommendations tailored based on their purchase history and/or other customer data. Thus, online vendors may provide personalized recommendations that do not rely upon the personal knowledge base of a particular salesperson. Online vendors may, therefore, provide a more consistent shopping experience.

With that said, there are still advantages of shopping in retail establishments which are commonly referred to as “brick and mortar” businesses in order to distinguish them from their online counterparts. One advantage of a brick and mortar business compared to its online counterpart is that a brick an mortar business may permit their customer to inspect, use, try, or otherwise test the product prior to purchase. For certain items (e.g., consumer electronics, clothing, etc.), the ability to try the product before purchasing is perceived as a big benefit by many customers.

Moreover, many customers still prefer the personal experience that a well-trained and helpful salesperson provides.

Given the different shopping experiences and advantages offered by brick and mortar businesses and online businesses, many vendors provided their customers with both brick and mortar and online options from which customers may purchase products. Such an organizational scheme permits catering to customers who primarily shop online, customers that primarily shop in a physical store, as well as customers that utilize both online and in-store shopping opportunities. The latter category, however, may present an issue to these vendors when trying to provide personalized recommendations. Since such customers split their purchases between online and in-store options, both the knowledgeable salesperson at the brick and mortar business and the online site are operating with incomplete purchase history even though such purchases are from the same organization. Such incomplete purchase history may negatively affect the effectiveness of product recommendations made by the salesperson and the online site.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Systems and methods for leveraging a customer's in-store activity for online applications such as networking with other customers, generating recommendations, forming interest groups, and/or any other appropriate manners of enhancing the social experience of a customer are substantially shown in and/or described in connection with at least one of the figures, and are set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 shows a product recommendation environment in accordance with an embodiment of the present invention.

FIG. 2 shows an embodiment of a computing device suitable for implementing various aspects of the product recommendation environment shown in FIG. 1.

FIG. 3 shows an embodiment of the product recommendation environment in FIG. 1.

FIG. 4 shows an embodiment of a product recommendation of the product recommendation environment shown in FIG. 1, in which the product recommendation is presented as a map.

### DETAILED DESCRIPTION OF THE INVENTION

As utilized herein, the term “e.g.” introduces a list of one or more non-limiting examples, instances, or illustration. Similarly, the term “embodiment” refers to a non-limiting example, instance, or illustration. The present disclosure may describe different embodiments having various features, aspects, elements, etc. It should be appreciated, however, that such features, aspects, elements, etc. of the described embodiments are not intended to be limiting. Other embodiments may have a different selection of the described features, aspects, elements while still falling within the scope of the appended claims. Therefore, it is intended that the present disclosure not be limited to the particular embodiment disclosed, but that the present disclosure will include all embodiments falling within the scope of the appended claims.

In currently known systems, information about a customer's in-store activity remains offline, and is not utilized in online applications such as social networking, generating recommendations, forming interest groups, and/or any other appropriate online application. The present disclosure relates generally to leveraging a customer's in-store activity for online applications such as networking with other customers, generating recommendations, forming interest groups, and/or any other appropriate means of enhancing the social experience of a customer. In particular, product recommendation systems and associated methods are disclosed, which recommend products and/or services to customers and which enhance social experiences of such customers.

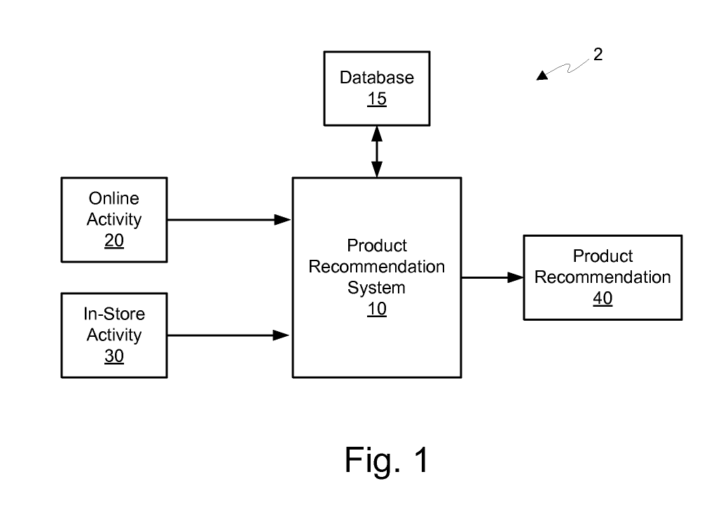

Details regarding various aspects of the present disclosure are now discussed in regard to a product recommendation environment 2 depicted in FIG. 1. As shown, a product recommendation system 10 may receive online activity data 20 and in-store activity data 30. The product recommendation system 10 may update one or more databases 15 based on the received data 20, 30. The product recommendation system 10 may further generate a product recommendation 40 based on the received online activity data 20, received in-store activity data 30, and/or previously received and stored data obtained from the database 15. As explained in further detail below, the online activity data 20 and in-store activity data 30 may include many different types of data and/or sources of data. Moreover, the product recommendation system 10 may generate various types of product recommendations and/or provide other types of services based on the received online and/or in-store data.

For example, the product recommendation system 10 may receive online and/or in-store activity data that includes a customer's purchase history, a customer's loyalty program profile, a customer's self-identifying information, a customer's address, a customers' shopping list, a customer's wish list and/or any appropriate other information about a customer. Moreover, besides data for the customer associated with the product recommendation 40, the activity data 20, 30 may also include in-store and online activity data for additional customers. The product recommendation system 10 may selected additional customers and their respective data based on whether the additional customers are in a customer's social network, the additional customers share a customer's geographic location, the additional customers have similar purchase histories, the additional customers have a similar loyalty rewards status, and/or any other appropriate manner of selection. Using a customer's online and offline activity data 20, 30, and the online and offline activity data of selected additional customers, the product recommendation system 10 may generate customized product recommendations 40 which may include suggestions, offers, promotions, advertisements etc. based on data received for a customer, and/or data received for other additional customers that are related to the customer.

In one embodiment, the product recommendation system 10, the database 15, and various sources of online activity data 20 and in-store activity data 30 may be implemented using one or more computing devices. Such computing devices may include personal data assistants, smart phones, tablets, laptops, in-store kiosks, point-of-sale terminals, desktops, workstations, servers, and/or or other computing devices.

Moreover, such computing devices may communicate with one another via one or more networks. Such networks may include a number of private and/or public networks such as, for example, wireless and/or wired LAN networks, cellular networks, and the Internet that collectively provide a communication path and/or paths between the online computing devices, in-store computing devices, the product recommendation system 10, and database 15. Moreover, the network and/or product recommendations system 10 may include one or more web servers, database servers, routers, load balancers, and/or other computing and/or networking devices.

Those skilled in the art readily appreciate that FIG. 1 depicts a simplified embodiment of a product recommendation environment 2 and that the product recommendation environment 2 may be implemented in numerous different manners using a wide range of different computing devices, platforms, networks, etc. Moreover, those skilled in the art readily appreciate that while aspects of the product recommendation environment 2 may be implemented using a client/server architecture, aspects of the product recommendation environment 2 may also be implemented using a peer to peer architecture or another networking architecture.

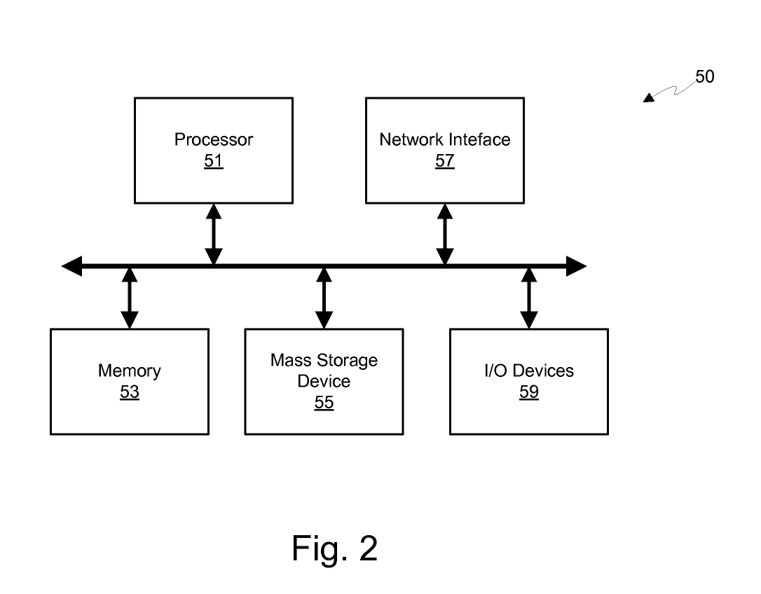

As noted above, the sources of online activity data 20, the sources of in-store activity data 30, the product recommendation system 10, and/or the database 15 may be implemented using various types of computing devices. FIG. 2 provides a simplified depiction of a computing device 50 suitable for implementing such computing devices. As shown, the computing device 50 may include a processor 51, a memory 53, a mass storage device 55, a network interface 57, and various input/output (I/O) devices 59. The processor 51 may be configured to execute instructions, manipulate data and generally control operation of other components of the computing device 50 as a result of its execution. To this end, the processor 51 may include a general purpose processor such as an x86 processor or an ARM processor which are available from various vendors. However, the processor 51 may also be implemented using an application specific processor and/or other circuitry.

The memory 53 may store instructions and/or data to be executed and/or otherwise accessed by the processor 51. In some embodiments, the memory 53 may be completely and/or partially integrated with the processor 51.

In general, the mass storage device 55 may store software and/or firmware instructions which may be loaded in memory 53 and executed by processor 51. The mass storage device 55 may further store various types of data which the processor 51 may access, modify, and/or otherwise manipulate in response to executing instructions from memory 53. To this end, the mass storage device 55 may comprise one or more redundant array of independent disks (RAID) devices, traditional hard disk drives (HDD), sold state device (SSD) drives, flash memory devices, read only memory (ROM) devices, etc.

The network interface 57 may enable the computing device 50 to communicate with other computing devices. To this end, the networking interface 57 may include a wired networking interface such as an Ethernet (IEEE 802.3) interface, a wireless networking interface such as a WiFi (IEEE 802.11) interface, a radio or mobile interface such as a cellular interface (GSM, CDMA, LTE, etc) or near field communication (NFC) interface, and/or some other type of networking interface capable of providing a communications link between the computing device 50 and a network and/or another computing device.

Finally, the I/O devices 59 may generally provide devices which enable a user to interact with the computing device 50 by either receiving information from the computing device 50 and/or providing information to the computing device 50. For example, the I/O devices 59 may include display screens, keyboards, mice, touch screens, microphones, audio speakers, digital cameras, optical scanners, etc.

While the above provides some general aspects of a computing device 50, those skilled in the art readily appreciate that there may be significant variation in actual implementations of a computing device. For example, a smart phone implementation of a computing device generally uses different components and may have a different architecture than a database server implementation of a computing device. However, despite such differences, computing devices still generally include processors that execute software and/or firmware instructions in order to implement various functionality. As such, the above described aspects of the computing device 50 are not presented from a limiting standpoint but from a generally illustrative standpoint. The present application envisions that aspects of the present application will find utility across a vast array of different computing devices and the intention is not to limit the scope of the present application to a specific computing device and/or computing platform beyond any such limits that may be found in the appended claims.

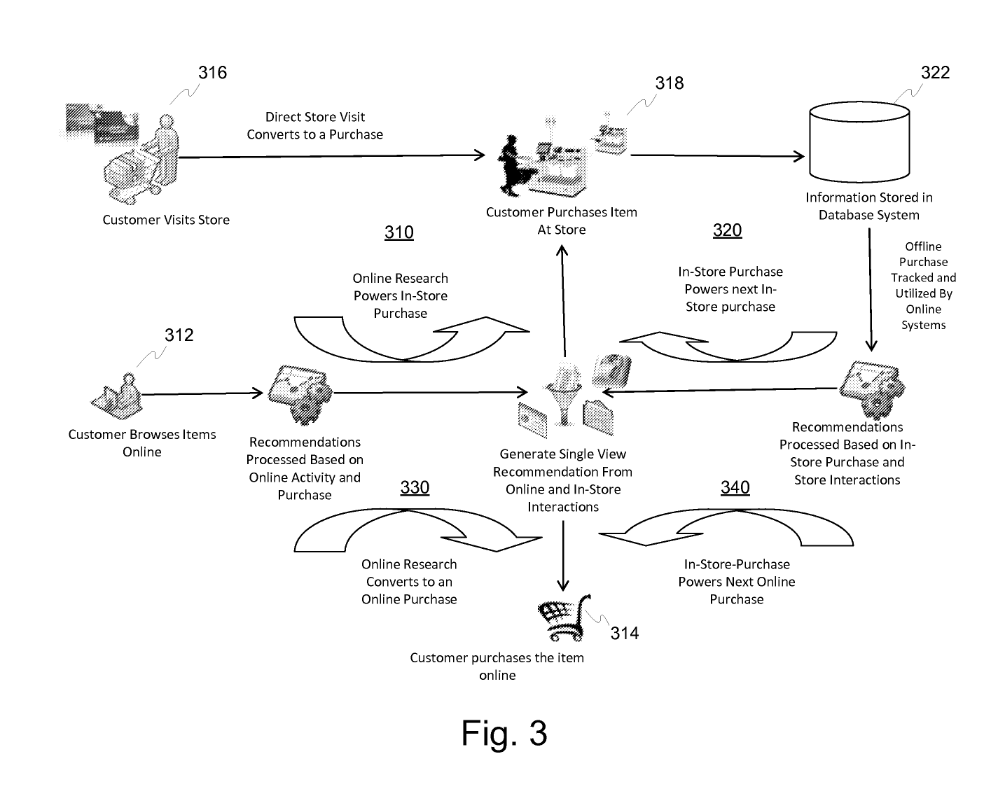

Referring now to FIG. 3, a more detailed depiction of one embodiment of the product recommendation environment 2 is show. In particular, the product recommendation environment 2 may combine in-store activity and online activity to provide a single view of recommendations for a customer, which is in contrast to a online view of recommendations based solely on online activity and in contrast to an in-store view of recommendations based solely on in-store activity. In particular, the recommendation environment 2 may deliver the same or similar level of product recommendations to a customer regardless of whether the customer is currently shopping in a physical retail location or online via an e-commerce website. Moreover, the product recommendation environment 2 may also deliver the same or similar level of product recommendations to a customer regardless of whether the customer shops solely in-store, solely online, primarily in-store, primarily online, or a relatively even mix of online and in-store activity.

FIG. 3 shows an embodiment of the product recommendation environment 2 of FIG. 1 in which both online activity and in-store activity drive online and in-store recommendations. In particular, the upper left quadrant depicts a data path 310 in which online activity drives in-store purchases and in-store recommendations. The upper right quadrant depicts a data path 320 in which in-store activity drives further in-store purchases and in-store recommendations. The lower left quadrant depicts a data path 330 in which online activity drives online purchases and online recommendations. Finally, the lower right quadrant depicts a data path 340 in which in-store activity drives online purchases and online recommendations.

Regarding the data path 330, the recommendation system 10 may receive data regarding various online activities of the customer. For example, using a computing device such as a tablet, smart phone, laptop, etc., the customer at 312 may browse and/or otherwise research products at one or more e-commerce sites affiliated or otherwise associated with the product recommendation system 10. In particular, the product recommendation system 10 may provide the customer with product recommendations 40 during the online shopping session. More specifically, the product recommendation system 10 may provide such recommendation based on information received during the present online shopping session as well as information received during previous online shopping sessions and/or previous in-store shopping events.

Based on such product recommendations 40 and/or online research, the customer at 314 may purchase one or more products from one or more e-commerce sites associated with the product recommendation system 10. As a result of such online activity, the product recommendation system 10 may receive data regarding products researched, browsed, purchased, etc. The product recommendation system 10 may then use such online activity data to drive product recommendations when the customer later shops at a brick and mortar store affiliated or otherwise associated with the product recommendation system 10.

With respect to data path 310, in response to the customer later entering a physical store at 316, the product recommendation system 10 may utilize the previously received online activity data as well as other information associated with the customer in order to provide the customer with customized product recommendations 40. For example, the product recommendation system 10 may receive a notification that the customer has entered the associated physical store. Such a notification may be sent to the product recommendation system 10 via several techniques. In one embodiment, the product recommendation system 10 may receive such notification via a mobile application which may be executed by a mobile device (e.g., a smart phone, tablet, personal data assistant, etc.) owned by the customer or owned by the physical store and lent to the customer upon entering the store and/or otherwise checking-in with the store. In such an embodiment, the mobile device may transmit information to the product recommendation system 10 such as the customer's location, the customer's status, the product(s) and/or service(s) that the customer is seeking, and or any other appropriate information. Such information may also be provided to the product recommendation system 10 via a salesperson or store associate who has spoken with the customer and gathered such information from the customer. In such an embodiment, the salesperson may enter various information regarding the customer interaction into a computing device that in turn provides such information to the product recommendation system 10.

The product recommendation system 10 may then use the received information to provide a variety of different services. For example, the product recommendation system 10 may forward the information and/or provide customized recommendations 40 to a store associate or salesperson in order to enable such associate or salesperson to better assist the customer with locating products of interest. In another embodiment, the product recommendation system 10 may process such received information along with possible other previously received data in order to create and transmit product recommendations 40 to the customer. The product recommendation system 10 may provide such recommendations to the customer via a mobile device, an in-store kiosk, a store associate, a salesperson, etc.

The product recommendation system 10 may further store the received information in database 15 in order to drive and refine future recommendations 40. For example, the product recommendation system 10 may use such stored data to assist in generating recommendations 40 during further shopping events, whether such shopping events occur at the same brick and mortar store, another brick and mortar store, another brick and mortar location, and/or an online store associated with the product recommendation system 10.

At 318, the customer may purchase one or more items from the brick and mortar store. In response to such purchase activity, the product recommendation system 10 may receive information regarding the purchased product. For example, a point-of-sale terminal may provide the product recommendation system 10 with information regarding the customer, the products purchased, etc. The product recommendation system 10 at 322 may then store such information in order to refine future recommendations 40 presented during further in-store shopping events as depicted via data path 320 and/or during further online shopping events as depicted at data path 340.

Data paths 310, 320, 330, and 340 depict either online activity or in-store activity driving either online recommendations or in-store recommendations. One skilled in the art, however, should appreciate that each of such data paths 310, 320, 330, 340 may affect the other data paths since the product recommendation system 10 may store data received as a result of one data path and use such received data to refine and generate recommendations regarding another data path. Accordingly, the product recommendation environment 2 not only involves the simple data paths 310, 320, 330, 340, but also the various combinations of such data paths 310, 320, 330, 340.

From the above, one skilled in the art should readily appreciate that the product recommendation system 10 may generate product recommendations based on online activity and in-store activity of a customer and/or related customers (e.g., additional customers in the customers social network, general geographic vicinity, etc.) Besides using a variety of data sources to generate the product recommendations 40, the product recommendation system 10 may also provide and/or otherwise present product recommendations to the customer at various times or in response to various different triggering events. For example, the product recommendation system 10 may present or provide a customer with recommendations 40 when a customer enters a brick and mortar store, when a customer visits an in-store kiosk, and/or when a customer checks-in to a store via a mobile application, kiosk, store associate, or other mechanism. The product recommendation system 10 may further present or provide a customer with recommendation 40 when a customer visits a certain location in a store, when a customer logs onto a website serviced by the product recommendation system 10, when a customer accesses a mobile device, and/or when a customer accesses a mobile application or computer application associated with the product recommendation system 10. The product recommendation system 10 may also present or provide a customer with recommendations 40 when a customer purchases a product at a point-of-sale terminal, when a customer communicates with another customer, and/or when a customer engages in any other suitable in-store and/or online activity.

Besides providing recommendations 40 at different times and/or in response to different triggering events, the product recommendation system 10 may also provide product recommendations 40 in various different forms. For example, the product recommendation system 40 may provide product recommendations 40 that identify one or more products as being “recommended” products for the customer. The product recommendations 40 may also take more subtle forms. For example, the product recommendations 40 instead of identifying products as “recommended” may instead list discounts, promotions, or other reduced pricing techniques on products for which the system 10 identified as recommended for the customer. In some embodiments, the discounts, promotions, etc. may be tailored to the particular customer and/or loyalty program and may be discounts, promotions, etc. that are not generally available to other customers.

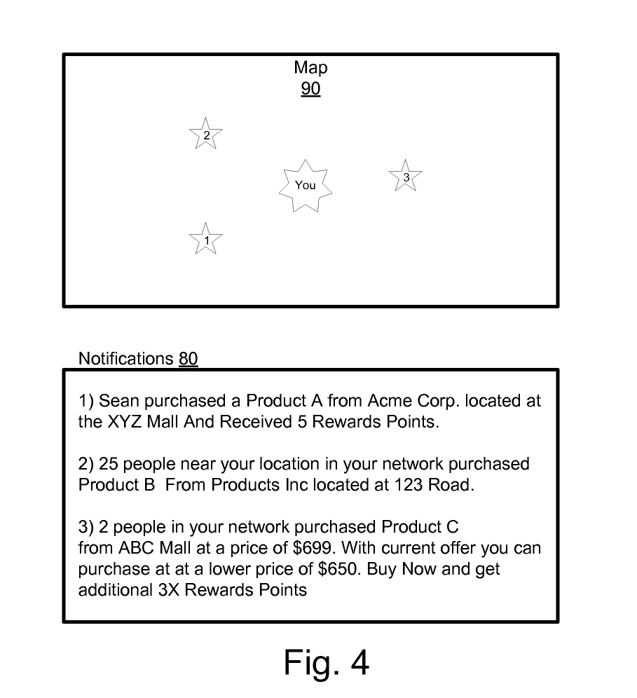

In some embodiments, the product recommendations 40 may be presented as one or more notifications 80 of other customers' activity as shown in FIG. 4. As noted above, the product recommendation system 10 may generate recommendations 40 for a customer based on information about related customers (e.g., other customers in the social network of the customer). For example, the product recommendation system 10 may receive information regarding products purchased by other customers in a customer's social network. The product recommendation system 10 may then provide the recommendation 40 as a notification of the other customer's purchase of the product. In some embodiments, the product recommendation system 10 does not notify the customer of all products purchased by other customer's in their network, but instead may provide the customer with notifications for products the system 10 would have otherwise recommended and/or may use such information to aid in the determination of which products to recommend to the customer. Such notifications may be presented to the customer via a number of different manners. For example, the customer may receive the notification/recommendation 40 via an email message received using a computing device, a text message received using a mobile phone, an activity timeline received via a social networking website, and/or notifications received via other communications channels.

Besides providing recommendations 40 as notifications 80 of other customers' activity, the product recommendation system 10 may also provide such notifications 80 in relation to a map 90 as shown in FIG. 4. In particular, the product recommendation system 40 may generate the map and select relevant activity for display on the map based on activity within a geographic vicinity of the customer (e.g., same or nearby zip codes, cities, area codes, store locations, etc.). In some embodiments, the product recommendation system 10 adjusts the relevant geographic vicinity based on the current location of the customer (e.g., brick and mortar store in which the customer is currently present) as opposed to a previously registered location of the customer (e.g., mailing address). In such embodiments, the product recommendation system 10 may select recent in-store and/or online activity for other customers based on personal relationship of such other customers to the customer, or based on products or product categories believed to be of interest to the customer.

Moreover, the notifications 80 and/or map 90 may provide price information which gives the customer greater price visibility on the current state of the market for a product or product category of interest. In particular, the customer may assess whether a current price for a product is a fair price or a “good deal” based on actual price data provided by notifications 80 and/or map 90 for purchases of such product or similar products in their geographic vicinity.

Various embodiments of the invention have been described herein by way of example and not by way of limitation in the accompanying figures. For clarity of illustration, exemplary elements illustrated in the figures may not necessarily be drawn to scale. In this regard, for example, the dimensions of some of the elements may be exaggerated relative to other elements to provide clarity. Furthermore, where considered appropriate, reference labels have been repeated among the figures to indicate corresponding or analogous elements.

Moreover, certain embodiments may be implemented as a plurality of instructions on a tangible, computer readable storage medium such as, for example, flash memory devices, hard disk devices, compact disc media, DVD media, EEPROMs, etc. Such instructions, when executed by one or more computing devices, may result in the one or more computing devices providing one or more tasks associated generating and/or providing a product recommendations to a customer in a manner as described above.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
receiving a request for a product recommendation for a customer; and
generating the product recommendation based on a purchase history for the customer that comprises in-store purchases from one or more brick and mortar stores and online purchases from one or more online stores.

2. The method of claim 1, further comprising:
receiving in-store purchase information comprising data associated with in-store purchases for a brick and mortar store; and
updating the purchase history for the customer based on the received in-store purchase information.

3. The method of claim 1, further comprising:
receiving online purchase information comprising data associated with online purchases for an online store; and
updating the purchase history for the customer based on the received online purchase information.

4. The method of claim 1, further comprising:
receiving shopping intent information comprising data identifying one or more characteristics of a product for which the customer intends to purchase;
wherein said generating further comprises generating the product recommendation based further on the received shopping intent information for the customer.

5. The method of claim 1, further comprising:
receiving an indication that the customer has check-in to a particular brick and mortar store; and
providing the customer at the particular brick and mortar store with the product recommendation;
wherein said generating comprises generating the product recommendation based further on one or more aspects of the particular brick and mortar store.

6. The method of claim 1, further comprising:
receiving an indication that the customer has check-in to a particular brick and mortar store; and
providing a salesperson at the particular brick and mortar store with the product recommendation for the customer;
wherein said generating comprises generating the product recommendation based further on one or more aspects of the particular brick and mortar store.

7. The method of claim 1, further comprising:
receiving an indication that the customer has check-in to a particular brick and mortar store;
receiving shopping intent information comprising data identifying one or more characteristics of a product for which the customer intends to purchase; and
providing the customer at the particular brick and mortar store with the product recommendation;
wherein said generating comprises generating the product recommendation based further on the received shopping intent information for the customer, one or more aspects of the particular brick and mortar, and one or more aspects of another brick and mortar store within a vicinity of the particular brick and mortar store.

8. The method of claim 1, further comprising:
receiving an indication that the customer has check-in to a particular brick and mortar store; and
receiving shopping intent information comprising data identifying one or more characteristics of a product for which the customer intends to purchase; and
providing the customer at the particular brick and mortar store with the product recommendation;
wherein said generating comprises generating the product recommendation based further on the received shopping intent information for the customer, one or more aspects of the particular brick and mortar store, and one or more aspects of an online store.

9. The method of claim 1, further comprising sending the product recommendation during an online shopping session of the customer.

10. The method of claim 1, further comprising sending the product recommendation as a geographic map of other customers in a vicinity of the customer who have purchased a product recommended by the product recommendation.

11. A product recommendation system, comprising:
a database system configured to store purchase history for a plurality of customers; and
a computing system configured to receive a request for a product recommendation for a customer, and to generate the product recommendation based on a purchase history for the customer maintained by the database system, wherein the purchase history for the customer includes data for in-store purchases from one or more brick and mortar stores and data for online purchases from one or more online stores.

12. The product recommendation system of claim 11, wherein the computing system is further configured to:
receive in-store purchase information comprising data associated with in-store purchases for a brick and mortar store; and
request the database system to update the purchase history for the customer in response to the received in-store purchase information.

13. The product recommendation system of claim 11, wherein the computing systems is further configured to:
receive online purchase information that includes data associated with online purchases for an online store; and
request the database system to update the purchase history for the customer in response to the received online purchase information.

14. The product recommendation system of claim 11, wherein the computing systems is further configured to:
receive shopping intent information from a mobile computing device of a customer, wherein the shopping intent information includes data identifying one or more characteristics of a product for which the customer intends to purchase;
generate the product recommendation based on the received shopping intent information.

15. The product recommendation system of claim 11, wherein the computing systems is further configured to:
receive an indication from a mobile computing device that the customer is in a particular brick and mortar store;
generate the product recommendation based on one or more aspects of the particular brick and mortar store; and
send the generated product recommendation to the mobile computing device;

16. The product recommendation system of claim 11, wherein the computing systems is further configured to:
receive, from a computing device at a particular brick and mortar store, an indication that the customer has checked-in;
generate the product recommendation based further on one or more aspects of the particular brick and mortar store; and
provide a salesperson at the particular brick and mortar store with the product recommendation for the customer;

17. The product recommendation system of claim 11, wherein the computing systems is further configured to:
receive an indication that the customer checked-in to a particular brick and mortar store;
receive shopping intent information that includes data identifying one or more characteristics of a product for which the customer intends to purchase; and
generate the product recommendation based on the received shopping intent information for the customer, one or more aspects of the particular brick and mortar, and one or more aspects of another brick and mortar store within a vicinity of the particular brick and mortar store; and
send the product recommendation to a computing device at the particular brick and mortar store.

18. The product recommendation system of claim 11, wherein the computing systems is further configured to:
receive an indication that the customer checked-in to a particular brick and mortar store;
receive shopping intent information that includes data identifying one or more characteristics of a product for which the customer intends to purchase;
generate the product recommendation based on the received shopping intent information for the customer, one or more aspects of the particular brick and mortar store, and one or more aspects of an online store; and
send the product recommendation to a computer device at the particular brick and mortar store.

19. The product recommendation system of claim 11, wherein the computing systems is further configured to send the product recommendation to a computing device during an online shopping session of the customer.

20. The product recommendation system of claim 11, wherein the computing systems is further configured to send the product recommendation as a geographic map of other customers in a vicinity of the customer who have purchased a product recommended by the product recommendation.
